(19) United States
(12) Patent Application Publication
(10) Pub. No.: US 2007/0223052 A1
(43) Pub. Date: Sep. 27, 2007

(54) Terminal device and medium for the same

(75) Inventor: Satoshi Suzuki, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/723,587

(22) Filed: Mar. 21, 2007

(30) Foreign Application Priority Data
Mar. 23, 2006 (JP) 2006-081132

(51) Int. Cl. H04N 1/00

(52) U.S. Cl. 358/407

(57) ABSTRACT

A terminal device having at least one function utilizable by a plurality of external devices interconnected with the terminal device via a network comprises an occupation setting system that sets an intended function in a state occupied by an external device specified as an occupation device that is an occupation requesting source, a function execution command receiving system, an occupation device judging system that judges whether a sending source of the function execution command is the occupation device, a communication judging system that judges whether communication of the terminal device with a device other than the occupation device is necessary, and a function execution permitting system that releases, for the device other than the occupation device, the occupied state and permits execution of a function corresponding to the function execution command.

### CROSS-REFERENCE TO RELATED APPLICATION

This application claims priority under 35 U.S.C. §119 from Japanese Patent Application No. 2006-081132, filed on Mar. 23, 2006. The entire subject matter of the application is incorporated herein by reference.

### BACKGROUND

1. Technical Field

The following description relates to one or more terminal devices, each of which is provided with a function that allows a specified device to occupy an intended function of the terminal device, and one or more computer usable media containing instructions to be executed by the terminal devices.

2. Related Art

Conventionally, there is known a printing device (terminal device) provided with an occupation function that allows a specified device (occupation device) to occupy a printing function of the printing device so as to avoid a situation where different sorts of printed papers are mixed.

In such a printing device, an occupation setting is configured in response to receiving requests for an occupation device, occupation starting time when the occupation device has started to occupy the printing function, and occupation term during which a state where the printing function is to be occupied by the occupation device. When receiving a request for performing a printing job during the occupation term, the printing device performs the printing job in the case where the request for performing the printing job has been issued from the same device as the occupation device as specified, while it rejects the printing job in the case where the request has been issued from a device other than the occupation device (for example, see Japanese Patent Provisional Publication No. 2000-330738).

However, since the aforementioned printing device does not at all accept the request for performing the printing job issued from devices other than the occupation device while configuring the occupation setting, when data stored in a device such as a data server different from the occupation device are required to be printed with the printing device, the data have to be once copied into the occupation device and directly sent from the occupation device. Therefore, it causes a problem that a procedure of printing the data stored in a device other than the occupation device is more complicated.

Such a problem can be caused in the same manner even in a terminal device provided with an occupation function for allowing a specified device to occupy various functions thereof, since when the terminal device is required to perform data communication with a device other than the occupation device based on a control command from the occupation device, the data to be transmitted between the terminal device and the device other than the occupation device have to be once copied into the occupation device.

### SUMMARY

Aspects of the present invention are advantageous in that there can be provided one or more improved terminal devices, each of which is provided with an occupation function for allowing a specified device to occupy various functions of the terminal devices and configured such that a transmission procedure for data to be transmitted between the terminal device and a device other than the specified device based on a control command from the specified device can be simplified.

### BRIEF DESCRIPTION OF THE ACCOMPANYING DRAWINGS

FIG. 1 schematically shows a configuration of a communication system in accordance with one or more aspects of the present invention.

FIG. 2 is an illustration schematically showing a correspondence list in which each function of an MFP is associated with a device necessary for executing the function in accordance with one or more aspects of the present invention.

FIG. 3 is a flowchart showing an MFP process (overall procedure) in accordance with one or more aspects of the present invention.

FIG. 4 is a flowchart showing an occupation setting portion of the MFP process in accordance with one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

General Overview

According to aspects of the present invention, there is provided a terminal device, provided with at least one function that can be utilized by a plurality of external devices interconnected with the terminal device via a network, which includes an occupation setting system configured to set an intended one of the at least one function of the terminal device in a state occupied by one of the plurality of external devices that is specified as an occupation device, the occupation device being an occupation requesting source that has requested to occupy the intended function, a function execution command receiving system configured to receive a function execution command that instructs the terminal device to execute one of the at least one function, an occupation device judging system configured to judge whether a sending source that has sent the function execution command received by the function execution judging system is the occupation device, a communication judging system configured to judge whether communication of the terminal device with a device other than the occupation device is necessary for executing the function corresponding to the function execution command in response to the sending source of the function execution command being judged to be the occupation device, and a function execution permitting system configured to release, for the device other than the occupation device, the occupied state where the function corresponding to the function execution command is occupied by the occupation device and permit execution of the function corresponding to the function execution command in response to the communication judging system judging that the communication of the terminal device with the device other than the occupation device is necessary.

According to some aspects, even though the intended function is set in the occupied state where the terminal device can accept only the function execution command for the intended function from the occupation device, the function execution command transmitted from a device other than the occupation device that corresponds to the function execution command transmitted from the occupation device can be accepted. Therefore, not all data corresponding the function execution command transmitted from the occupation device are required to be stored in the occupation device. Hence, when data communication of the terminal device with the device other than the occupation device is necessary in accordance with a control command from the occupation device, a procedure of the data communication can be simplified.

Optionally, the terminal device may further include a storing system configured to store occupation requesting source information specifying the occupation requesting source therein, an occupation requesting source information receiving system configured to receive the occupation requesting source information from the sending source of the function execution command, and an occupation requesting source judging system configured to judge that the sending source of the function execution command is the occupation requesting source in the case where the occupation requesting source information received by the occupation requesting source information receiving system is identical to the occupation requesting source information stored in the storing system, even though the occupation device judging system judges that the sending source of the function execution command is different from the occupation device.

According to some aspects, when the occupation requesting source information such as a password, user ID, and an IP address and node name of the occupation device is inputted, a control command from a device other than the occupation device can be accepted. Thereby, the user-friendliness of the terminal device can be improved.

Yet optionally, the terminal device may further include an input system configured such that each of the function execution command and the occupation requesting source information can be inputted with the input system being operated by a user. In this case, the function execution command receiving system may be configured to receive the function execution command inputted through the input system, and the occupation requesting source information receiving system may be configured to receive the occupation requesting source information inputted through the input system.

According to some aspects, the control command and occupation requesting source information can be inputted through the input system provided to the terminal device (e.g., operating panel, operating buttons, and operating keys). Thereby, the user-friendliness of the terminal device can be improved.

Optionally, the terminal device may be configured such that each of a plurality of functions provided thereto can be set in the occupied state where each of the plurality functions is occupied by a corresponding occupation device. In this case, the terminal device may further include an occupied function judging system configured to judge whether each function set in the occupied state by the occupation setting system is necessary for executing a function corresponding to the function execution command received by the function execution command receiving system. Further, in response to the occupied function judging system judging that each function set in the occupied state is unnecessary, the function execution permitting system may permit execution of the function corresponding to the function execution command.

According to some aspects, when the terminal device is provided with a plurality of functions, each of the plurality of functions can be set in the occupied state where each of the plurality of functions is occupied by a corresponding occupation device. Therefore, even though some of the plurality of functions are set in the occupied state, when a function to be utilized is not in the occupied state, the function to be utilized can be executed in response to the function execution command.

Optionally, the terminal device may further include an occupied function judging system configured to judge whether a function corresponding to the function execution command received by the function execution command receiving system is set in the occupied state by the occupation setting system. Further, in response to the occupied function judging system judging that the function corresponding to the function execution command is not set in the occupied state, the function execution permitting system may permit execution of the function corresponding to the function execution command.

According to some aspects, when a function to be utilized is not in the occupied state, the function to be utilized can be executed in response to the function execution command.

Optionally, the terminal device may be configured such that each of a plurality of functions provided thereto can be set in the occupied state where each of the plurality functions is occupied by a corresponding occupation device. In this case, the occupation setting system may be configured to set each of an intended function and functions associated with device portions of the terminal device that are necessary for executing the intended function among the plurality of functions in the state occupied by the external device specified as the occupation device.

According to some aspects, each of the intended function and functions associated with device portions included in the terminal device that are necessary for executing the intended function can be set in the state occupied by the external device specified as the occupation device. Thereby, it is possible to avoid a situation where different functions occupied by respective occupation devices that require the same device portion of the terminal device for executing them conflict with each other.

According to another aspect of the present invention, there is provided a computer usable medium having computer readable instructions stored thereon, which, when executed by a processor included in a terminal device provided with at least one function that can be utilized by a plurality of external devices interconnected with the terminal device via a network, cause the processor to set an intended one of the at least one function of the terminal device in a state occupied by one of the plurality of external devices that is specified as an occupation device, the occupation device being an occupation requesting source that has requested to occupy the intended function, receive a function execution command that instructs the terminal device to execute one of the at least one function, judge whether a sending source that has sent the function execution command as received is the occupation device, judge whether communication of the terminal device with a device other than the occupation device is necessary for executing the function corresponding to the function execution command in response to the sending source of the function execution command being judged to be the occupation device, release, for the device other than the occupation device, the occupied state where the function corresponding to the function execution command is occupied by the occupation device, and permit execution of the function corresponding to the function execution command in response to judgment that the communication of the terminal device with the device other than the occupation device is necessary.

According to some aspects, the computer usable medium configured as aforementioned has the instructions that actualize the operations performed by the terminal device configured as above. Therefore, the same effects as the aforementioned terminal device can be expected.

Illustrative Aspects

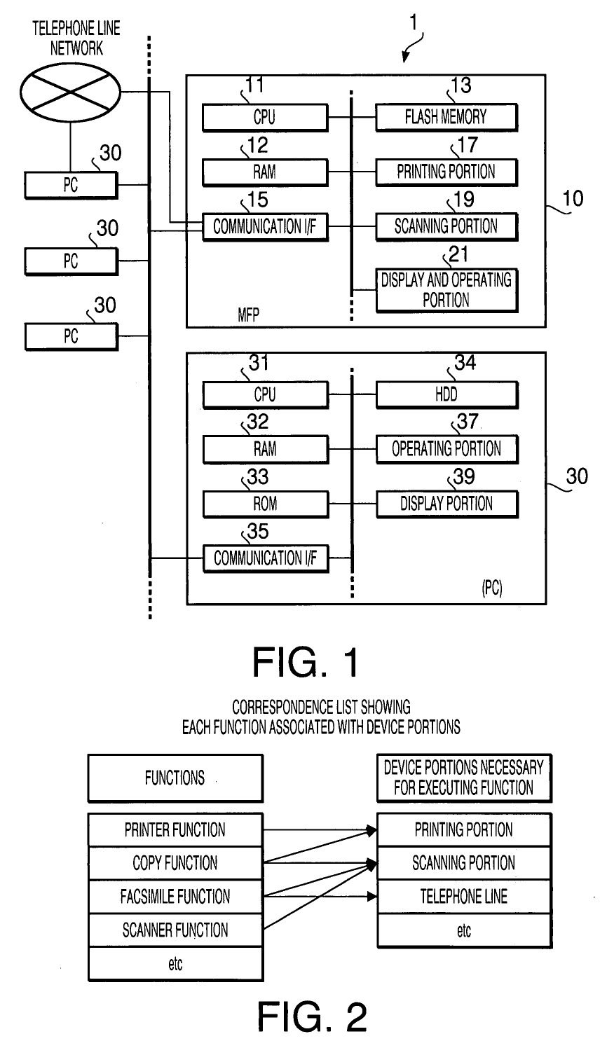

Hereinafter, an embodiment according to the present invention will be described with reference to the accompanying drawings. FIG. 1 schematically shows a configuration of a communication system 1 in the embodiment. As shown in FIG. 1, the communication system 1 in the embodiment is configured with a digital MFP (Multi Function Peripheral) (hereinafter, simply referred to as an “MFP”) 10 (terminal device) and personal computers (hereinafter, simply referred to as “PCs”) 30 being connected with a TCP/IP network. In particular, in the embodiment, at least one MFP 10 and a plurality of PCs 30 are interconnected through the network.

The MFP 10 is provided with a CPU 11, RAM 12 as a work memory, flash memory 13 that stores various programs and data therein, communication interface 15 connected with the TCP/IP network and a telephone line network, printing portion 17 that forms an image on a paper with a laser printing method or an inkjet printing method, scanning portion 19 that optically reads out an original placed on a mount stage, and display and operating portion 21 as a user interface including various user-operable keys and a display portion. The MFP 10 is configured to execute various programs with the CPU 11 so as to actualize a printer function, scanner function, copy function, facsimile function, and the like.

For example, when receiving printing data from a PC 30 through the communication interface 15, the CPU 11 controls the printing portion 17 to form a printing image based on the printing data on the paper (printer function). In addition, when a scanning command is inputted with the display and operating portion 21 being operated by a user, the CPU 11 controls the scanning portion 19 to form image data corresponding to an image obtained by scanning the original on the mount stage and transmit the image data as formed to a predetermined PC 30 via the communication interface 15 (scanner function). Further, when receiving printing data via the telephone line network and communication interface 15, the CPU 11 forms a printing image based on the received printing data on the paper, or the CPU 11 transmits image data formed by the scanner function to an external device via the communication interface 15 and telephone line network (facsimile function).

Additionally, the MFP 10 is provided with a web server function and occupation function that, in response to a function execution command for executing a function which has been issued from a device as a occupation requesting source other than an occupation device, rejects execution of a function of the MFP 10 corresponding to the function execution command and allows the occupation device (PC 30) to occupy the corresponding function.

Meanwhile, each of the PCs 30 in the embodiment, configured in the same fashion as a widely known personal computer, executes various programs with the CPU 31 to perform a process of transmitting an occupation request for allowing the PC 30 to occupy the MFP 10. Specifically, the PC 30 is provided with a CPU 31, RAM 32 as a work memory, ROM 33 that stores a boot program therein, hard disk drive (HDD) 34, communication interface 35 connected with the TCP/IP network, operating portion 37 including a keyboard and pointing device, and display portion 39 including a liquid crystal monitor.

In such a communication system 1, there is stored in the flash memory 13 of the MFP 10, as shown in FIG. 2, a correspondence list in which each of the functions of the MFP 10 is associated with device portions necessary for executing each of the functions. The MFP 10 is configured such that each of the functions of the MFP 10 can be occupied by a specified PC 30 (occupation device).

In the correspondence list; for example, the “printer function” is associated with the “printing portion 17”, and the “copy function” is associated with the “printing portion 17” and “scanning portion 19”. Further, the “facsimile function” is associated with the “scanning portion 19” and “telephone line”, and the “scanner function” is associated with the “scanning portion 19”.

Referring to the correspondence list, when an occupation setting for occupying the “printer function” is configured by a certain device (any one of the PCs 30), occupation settings for occupying other functions (in this case, “copy function”) using the “printing portion 17” used for actualizing the “printer function” are concurrently configured. It is noted that, in this case, since occupation settings are not configured for the “facsimile function” and “scanner function” that do not use the “printing portion 17”, an arbitrary device (each of the PCs 30) can use the “facsimile function” and “scanner function”.

Thus, the CPU 11 of the MFP 10 stores an IP address specifying the PC 30 as an occupation requesting source and the functions for which the occupation settings have been configured in a manner associated with each other in the flash memory 13. In addition, the CPU 11 of the MFP 10 stores a password for temporarily releasing the occupation setting for each of the functions as well in the flash memory 13.

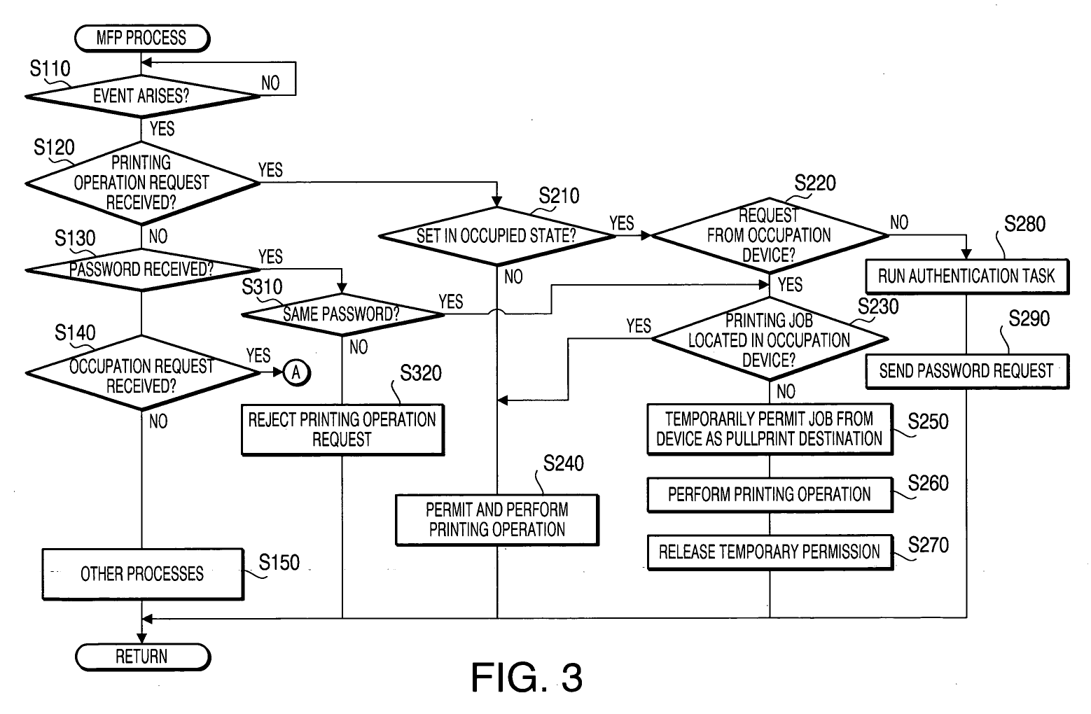

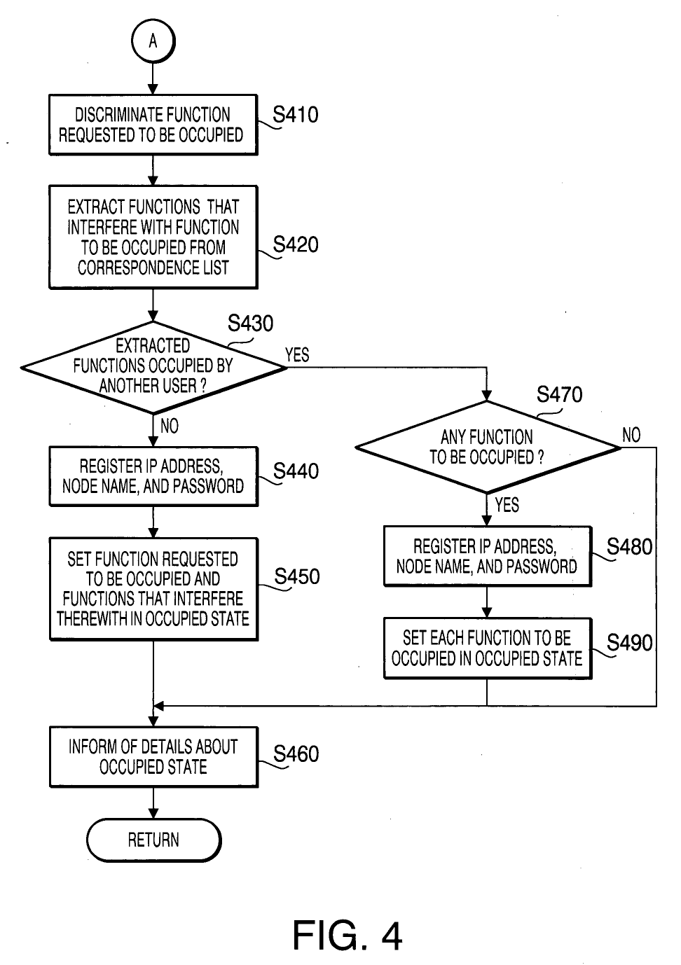

In such a communication system 1, the MFP 10 executes processes shown in FIGS. 3 and 4 in response to an access from one of the PCs 30. It is noted that FIGS. 3 and 4 are flowcharts showing an MFP process (program) to be executed by the CPU 11 of the MFP 10.

The MFP process is started after the MFP 10 has been booted. When the MFP starts to execute the MFP process, the CPU 11 judges whether an event such as an access to a printing port, reception of an input signal inputted through the display and operating portion 21, and reception of packets from one of the PCs 30 or another MFP 10 arises (S110).

When it is not judged that an event arises (S110: No), the CPU 11 repeats the step of S110. Meanwhile, when it is judged that an event arises (S110: Yes), the CPU 11 judges whether the event is a reception of a printing operation request (function execution command) (S120). When it is judged that the event is the printing operation request. (S120: Yes), the process goes to a step of S210. Meanwhile, when it is not judged that the event is the printing operation request (S120: No), the CPU 11 judges whether a password has been received through the display and operating portion 21 or the communication interface 15 (S130).

When it is judged that a password has been received (S130: Yes), the process goes to a step of S130. Meanwhile, when it is not judged that a password has been received (S130: No), the CPU 11 judges whether an occupation request has been received from one of the PCs 30 (S140).

When it is judged that an occupation request has been received (S140: Yes), the process goes to a step of S410 shown in FIG. 4. Meanwhile, when it is not judged that an occupation request has been received (S140: No), the CPU 11 executes another operation corresponding to a sort of the event (S150), and repeats the MFP process from the beginning.

Next, in the step of S210 to which the process goes in the case where the printing operation request has been received in the step of S120, with reference to the flash memory 13, the CPU 11 judges whether a function (in this case, the “printer function”) to be utilized in response to what the event represents is set in an occupied state (S210).

When it is not judged that the function to be utilized is set in the occupied state (S210: No), the process goes to a step of S240. Meanwhile, when it is judged that the function to be utilized is set in the occupied state (S210: Yes), the CPU 11 judges whether the printing operation request has been issued from the occupation device (S220).

It is noted that, in this judgment, it is judged whether an IP address included in header data of the printing operation request (packet) is identical to an IP address corresponding to the function that is stored in the flash memory 13.

When it is judged that the printing operation request has been issued from the occupation device (S220: Yes), the CPU 11 judges whether a printing job corresponding to the printing operation is located in the PC 30 specified as the occupation device (S230).

Such a judgment is made here to prevent the printing operation request from being rejected due to the MFP 10 being set in the occupied state, in a state where printing data corresponding to the printing operation request is stored in a device (e.g., data server) other than the device transmitting the printing operation request, when a job for the printing data is executed (i.e., when a pullprint operation is performed), even though a source of the printing operation request is the occupation device.

When it is judged that the printing job corresponding to the printing operation is located in the PC 30 specified as the occupation device (S230: Yes), the printing operation is allowed and performed (S240). After completing the printing operation, the CPU 11 repeats the MFP process from the beginning.

Meanwhile, when it is not judged that the printing job corresponding to the printing operation is located in the PC 30 specified as the occupation device (S230: No), the job from a PC 30 as a pullprint destination is temporarily permitted (S250). This operation sets the MFP 10 in a state where the MFP 10 can accept only the job from the PC 30 as the pullprint destination, even though the printer function of the MFP 10 is set in the occupied state.

Subsequently, a printing operation regarding the printing operation request is carried out (S260). Then, the temporary permission in the step of S250 is released (S270), and the MFP process is repeated from the beginning. Meanwhile, when it is not judged that the printing operation request has been issued from the occupation device (S220: No), an authentication task for specifying a device that has transmitted the printing operation request as the occupation device is run (S280).

Then, a password request is sent to the sending source of the printing operation request (S290), and the MFP process is repeated from the beginning. Next, in the step of S130, when it is judged that a password has been received (S130: Yes), it is judged whether the password as received is identical to a password stored in the flash memory 13 for releasing the occupation setting for the printer function (S310). When it is judged that the password is identical to a password stored in the flash memory 13 for releasing the occupation setting for the printer function (S310: Yes), the process goes to the step of S230. Meanwhile, when it is not judged that the password is identical to a password stored in the flash memory 13 for releasing the occupation setting for the printer function (S310: No), the printing operation request is rejected (S320), and the MFP process is repeated from the beginning.

Next, in the step of S140, when it is judged that an occupation request has been received (S140: Yes), a function corresponding to the occupation request is discriminated (S410). Namely, in the step, a function requested to be occupied (e.g., the facsimile function) is discriminated.

Subsequently, the CPU 11 extracts functions that interfere with a function requested to be occupied from the correspondence list (see FIG. 2) stored in the flash memory 13 (S420). For example, when a function requested to be occupied is the facsimile function, in the step of S420, the copy function and the scanner function are extracted as the functions that interfere with the function requested to be occupied.

Then, it is judged whether any of the functions extracted as functions to be occupied is occupied by another user (S430). When it is not judged that any of the functions extracted as functions to be occupied is occupied by another user (S430: No), there are registered the IP address and node name specifying the PC 30 as the occupation requesting source, and the password for temporarily releasing the occupation setting (S440), and the function corresponding to the occupation request and the functions that interfere therewith are set in the occupied state (S450). Namely, the IP address, node name, and password are stored in the flash memory 13, associated with each of the functions extracted as functions to be occupied. It is noted that the password registered in the step of S440 may be a previously set password or a password to be inputted from the PC 30 as the occupation requesting source.

Subsequently, the CPU 11 informs the PC 30 as the occupation requesting source of details regarding the occupied state (S460), and repeats the MFP process. Meanwhile, in the step of S430, it is judged that any of the functions extracted as functions to be occupied is occupied by another user (S430: Yes), it is judged whether there is a function that has not yet been occupied among the extracted functions (S470).

When it is not judged that there is a function that has not yet been occupied (S470: No), the process goes to a step of S460, the CPU 11 informs the PC 30 as the occupation requesting source that no function can be set in the occupied state. In the meantime, when it is judged that there is a function that has not yet been occupied (S470: Yes), the IP address, node name, and password are registered for each of the functions that have not yet been occupied in the same manner as the step of S440 (S480), and each of the functions that have not yet been occupied is set in the occupied state (S490). Then, the CPU 11 informs the PC 30 as the occupation requesting source of details regarding the occupied state (S460), and repeats the MFP process.

It is noted that options regarding whether to release the occupied state can be selected at timing, such as, after a predetermined time period, when the function execution command has not received from the occupation requesting source for a predetermined time period, and when an instruction for releasing the occupied state has been received from the occupation requesting source, in the case where the occupation request is issued.

In the communication system 1 as aforementioned in detail, during a period when a function to be occupied is set by the occupation function in the occupied state where the function is occupied by the occupation device (PC 30), in response to the function execution command from a device other than the occupation device (specified PC 30) as the occupation requesting source, the MFP 10 rejects execution of a function thereof corresponding to the function execution command.

In addition, the MFP 10 receives the function execution command in the MFP process (S120), and judges whether a sending source that has sent the function execution command is the occupation requesting source by checking whether a device as a sending source of the function execution command as received is the occupation device (S220). Then, when judging that the sending source that has sent the function execution command is the occupation requesting source (S220: Yes), the MFP 10 judges whether communication with a device other than the occupation device is necessary to execute the function corresponding to the function execution command as received (S230).

Subsequently, when it is judged that communication with a device other than the occupation device is necessary, the MFP 10 releases, for a device other than the occupation device, the occupied states for only functions required to be executed in response to the function execution command from the occupation device, and permits execution of the required functions (S250).

Thus, according to such an MFP 10, even though the MFP 10 is set in the occupied state where only the function execution command from the occupation device can be accepted, a function execution command from a device other than the occupation device, which corresponds to the function execution command from the occupation device, can be accepted. Therefore, since data corresponding to the function execution command from the occupation device are not required to be stored in all of the occupation devices, when data communication with a device other than the occupation device is required in accordance with a control command from the occupation device, a procedure for the data communication can be simplified.

In addition, the MFP 10 in the embodiment is provided with the flash memory 13 that stores occupation requesting source information specifying the occupation requesting source therein. In the MFP process, the MFP 10 receives the occupation requesting source information from the sending source of the function execution command (S130). Even though it is judged that the sending source of the function execution command as received is not the occupation device, when occupation requesting source information as received is identical to the occupation requesting source information stored in the flash memory 13, the sending source that has sent the function execution command is judged to be the occupation requesting source (S310).

Hence, by inputting a password, user ID, and the occupation requesting source information such as the IP address and node name of the occupation device that have been registered when each of the functions to be occupied of the MFP 10 have been set in the occupied state, the MFP 10 as aforementioned can accept the control command even from a device other than the occupation device. Thereby, user-friendliness can be improved.

Further, the MFP 10 in the embodiment may be configured to receive the function execution command and occupation requesting source information inputted through the display and operating portion 21, which is provided for inputting the function execution command and occupation requesting source information in accordance with user's operations, in the steps of S120 and S130 in the MFP process.

According to the aforementioned MFP 10, since the control command and occupation requesting source information can be inputted through the display and operating portion 21 provided to the MFP 10 (e.g., operating panel, operating buttons, operating keys, and the like), user-friendliness can be improved. For example, firstly, the MFP 10 is set in the occupied state, and a print instruction is issued from the occupation device. At this time, a printing operation is performed based on the print instruction that is the function execution command from the occupation device. Next, even in the case where the user goes to the MFP 10 to take printed papers and sends the printed papers with the facsimile function of the MFP 10, the function execution command can be accepted based on an operation of the display and operating portion 21 without releasing the occupied state.

Further, the MFP 10 in the embodiment is configured such that each of the functions provided thereto can be set in the occupied state. In the MFP process, it is judged whether each function set in the occupied state is necessary for executing a function corresponding to the function execution command (S210). When it is not judged that each function set in the occupied state is necessary, the MFP 10 is set such that the function corresponding to the function execution command is allowed to be executed (S240).

According to the aforementioned MFP 10, when the MFP 10 has a plurality of functions, each of the plurality of functions can be set in the occupied state. Therefore, even some of the functions are set in the occupied state, when a function to be used is not set in the occupied state, the function to be used that corresponds to the function execution command can be executed.

It is noted that the present invention is not limited to the aforementioned embodiment, and various sorts of modifications may be possible as far as they are within a technical scope of the present invention. For example, in the embodiment, a process to be executed in response to the printing operation requirement has been exemplified. However, the present invention can be applied to an operation other than the printing operation by the printer function such as operations by the copy function, scanner function, and facsimile function.

In addition, when each of the functions to be occupied is set in the occupied state, in the embodiment, the IP address, node name, and password are registered (see S440 and S480). However, information to be registered is not limited to them, and any information that can specify the occupation device may be registered. Further, in the setting into the occupied state, the occupation request may be made through the display and operating portion 21 of the MFP 10. In this case, when any of the information as registered at this time is inputted and transmitted as information for specifying the sending source of the function execution command and correspondence of the inputted information to the registered information is recognized, the sending source of the function execution command can be specified as the occupation device.

Further, when the function execution command is issued, if the user previously transmits the occupation requesting source information, it can be judged whether the sending source of the function execution command is the occupation requesting source without transmitting a request for sending the occupation requesting source information.

In the embodiment, the password is required after the printing operation requirement has been received. However, for example, when the function execution command is issued by an operation through the display and operating portion 21 of the MFP 10, the display and operating portion 21 may previously be set not to accept an operation for the function execution command in the case where the occupation requesting source information has not been received. In this case, when it is judged that the password that has previously been received is identical to the registered password, the function execution command is received and the function corresponding to the function execution command is executed without checking whether the function execution command has come from the occupation device.

The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without resorting to the details specifically set forth. In other instances, well known processing structures have not been described in detail, in order not to unnecessarily obscure the present invention.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

What is claimed is:

1. A terminal device provided with at least one function that can be utilized by a plurality of external devices interconnected with the terminal device via a network, comprising:
an occupation setting system configured to set an intended one of the at least one function of the terminal device in a state occupied by one of the plurality of external devices that is specified as an occupation device, the occupation device being an occupation requesting source that has requested to occupy the intended function;
a function execution command receiving system configured to receive a function execution command that instructs the terminal device to execute one of the at least one function;
an occupation device judging system configured to judge whether a sending source that has sent the function execution command received by the function execution judging system is the occupation device;
a communication judging system configured to judge whether communication of the terminal device with a device other than the occupation device is necessary for executing the function corresponding to the function execution command in response to the sending source of the function execution command being judged to be the occupation device; and
a function execution permitting system configured to release, for the device other than the occupation device, the occupied state where the function corresponding to the function execution command is occupied by the occupation device and permit execution of the function corresponding to the function execution command in response to the communication judging system judging that the communication of the terminal device with the device other than the occupation device is necessary.

2. The terminal device according to claim 1, further comprising:
a storing system configured to store occupation requesting source information specifying the occupation requesting source therein;
an occupation requesting source information receiving system configured to receive the occupation requesting source information from the sending source of the function execution command; and
an occupation requesting source judging system configured to judge that the sending source of the function execution command is the occupation requesting source in the case where the occupation requesting source information received by the occupation requesting source information receiving system is identical to the occupation requesting source information stored in the storing system, even though the occupation device judging system judges that the sending source of the function execution command is different from the occupation device.

3. The terminal device according to claim 2, further comprising an input system configured such that each of the function execution command and the occupation requesting source information can be inputted with the input system being operated by a user,
wherein the function execution command receiving system is configured to receive the function execution command inputted through the input system, and
wherein the occupation requesting source information receiving system is configured to receive the occupation requesting source information inputted through the input system.

4. The terminal device according to claim 1,
wherein the terminal device is configured such that each of a plurality of functions provided thereto can be set in the occupied state where each of the plurality functions is occupied by a corresponding occupation device,
wherein the terminal device further comprises an occupied function judging system configured to judge whether each function set in the occupied state by the occupation setting system is necessary for executing a function corresponding to the function execution command received by the function execution command receiving system, and
wherein, in response to the occupied function judging system judging that each function set in the occupied state is unnecessary, the function execution permitting system permits execution of the function corresponding to the function execution command.

5. The terminal device according to claim 1,
wherein the terminal device further comprises an occupied function judging system configured to judge whether a function corresponding to the function execution command received by the function execution command receiving system is set in the occupied state by the occupation setting system, and
wherein, in response to the occupied function judging system judging that the function corresponding to the function execution command is not set in the occupied state, the function execution permitting system permits execution of the function corresponding to the function execution command.

6. The terminal device according to claim 1,
wherein the terminal device is configured such that each of a plurality of functions provided thereto can be set in the occupied state where each of the plurality functions is occupied by a corresponding occupation device,
wherein the occupation setting system is configured to set each of an intended function and functions associated with device portions of the terminal device that are necessary for executing the intended function among the plurality of functions in the state occupied by the external device specified as the occupation device.

7. A computer usable medium having computer readable instructions stored thereon, which, when executed by a processor included in a terminal device provided with at least one function that can be utilized by a plurality of external devices interconnected with the terminal device via a network, cause the processor to:
set an intended one of the at least one function of the terminal device in a state occupied by one of the plurality of external devices that is specified as an occupation device, the occupation device being an occupation requesting source that has requested to occupy the intended function;
receive a function execution command that instructs the terminal device to execute one of the at least one function;
judge whether a sending source that has sent the function execution command as received is the occupation device;
judge whether communication of the terminal device with a device other than the occupation device is necessary for executing the function corresponding to the function execution command in response to the sending source of the function execution command being judged to be the occupation device;
release, for the device other than the occupation device, the occupied state where the function corresponding to the function execution command is occupied by the occupation device; and
permit execution of the function corresponding to the function execution command in response to judgment that the communication of the terminal device with the device other than the occupation device is necessary.
